(19) United States
(12) Patent Application Publication
(10) Pub. No.: US 2019/0294385 A1
(43) Pub. Date: Sep. 26, 2019

(54) METHOD AND SYSTEM FOR ARRANGING AND PRINTING PAGES ACCORDING TO SEARCH CRITERIA

(71) Applicant: Xerox Corporation, Norwalk, CT (US)

(72) Inventors: Nagarajan Narasimhan, Chennai (IN); Shoban Kumar Jayaraj Devadoss, Chennai (IN); Ramkumar Rajasekaran, Chennai (IN); Sampath Amadagani, Chennai (IN); Sandhyakiran Giri, Chennai (IN); Padmavathi Muthusamy, Chennai (IN)

(21) Appl. No.: 15/928,493

(22) Filed: Mar. 22, 2018

(51) Int. Cl. G06F 3/12; G06F 17/30; H04N 1/00

(52) U.S. Cl. CPC G06F 3/1204; G06F 17/30554; G06F 3/1219; H04N 1/00161; H04N 1/00384; H04N 1/0044

(57) ABSTRACT

A system, method, and apparatus for selective document rendering comprises a rendering device, at least one processor; and a storage device communicatively coupled to the at least one processor, the storage device storing instructions which, when executed by the at least one processor, cause the at least one processor to perform operations comprising: searching at least one data location, returning results of the search, selecting discrete members of the search results, and printing the selected discrete members.

### TECHNICAL FIELD

Embodiments are generally related to the field of printing. Embodiments are further related to the field of computer and printing technology. Embodiments are also related to methods, systems, and devices for keyword searching. Embodiments are further related to methods, systems, and devices for identifying certain pages according to search criteria, and printing identified pages or sections. Embodiments are further related to methods, systems, and devices configured to print pages listed from multiple files in a folder as a result of keyword search criteria in a digital document and to methods, systems, and devices to print only those pages listed in a PDF or other document as a result of a keyword search of digital data.

### BACKGROUND

Advancing business demand for printing related services has resulted in increasingly complex printing requirements. For example, in an effort to reduce printing overhead and reduce waste, it may be desirable to selectively print pages, from long, and otherwise irrelevant, sections of a document, or group of documents.

Currently, certain software includes the option to search and list pages for a specific keyword, or keywords, in a digital document or group of digital documents. However, if a user wishes to render the documents or pages identified according to the search within one or more integrated documents, the options are limited. The user is forced either to print the entire document, or group of documents, and then manually select those pages identified by the search, or separately initiate a print command for each identified page. In either case, the time required to manage this process is time consuming and wasteful.

Accordingly, there is a need in the art for methods and systems that facilitate the ability to print only those pages or documents identified as the result of a search, as described in the embodiments disclosed herein.

### BRIEF SUMMARY

The following summary is provided to facilitate an understanding of some of the innovative features unique to the embodiments disclosed and is not intended to be a full description. A full appreciation of the various aspects of the embodiments can be gained by taking the entire specification, claims, drawings, and abstract as a whole.

It is, therefore, one aspect of the disclosed embodiments to provide a method, system, and apparatus for printing documents.

It is another aspect of the disclosed embodiments to provide a method, system, and apparatus for searching one or more documents and enabling print capability for the identified documents.

It is another aspect of the disclosed embodiments to provide a method, system, and apparatus for selectively printing documents, pages, sections, folders, sub-folders, or the like according to the results of a search of such documents, pages, sections, folders, sub-folders, or the like.

In the embodiments disclosed herein, a system and method comprise a rendering device, at least one processor; and a storage device communicatively coupled to the at least one processor, the storage device storing instructions which, when executed by the at least one processor, cause the at least one processor to perform operations comprising searching at least one data location, returning results of the search, selecting discrete members of the search results, and printing the selected discrete members.

The instructions, when executed by the at least one processor, cause the at least one processor to perform operations further comprising selecting parameters for the search. The parameters comprise at least one of a keyword, a header, a header section, a section, and a sub-section.

The instructions, when executed by the at least one processor, cause the at least one processor to perform operations further comprising selecting at least one data location for searching. The data location comprises at least one of a document, multiple documents, a folder, and a sub-folder. In an embodiment, the data location comprises at least one of the storage device, a local storage device, and a cloud storage location.

In another embodiment, the system further comprises a graphical user interface, the graphical user interface comprising at least one field for entering data, a field for displaying results of the search, an input for selecting discrete members of the search results, and a button for printing the selected discrete members of the search results.

### BRIEF DESCRIPTION OF THE FIGURES

The accompanying figures, in which like reference numerals refer to identical or functionally-similar elements throughout the separate views and which are incorporated in and form a part of the specification, further illustrate the embodiments and, together with the detailed description, serve to explain the embodiments disclosed herein.

FIG. 1 depicts a block diagram of a computer system which is implemented in accordance with the disclosed embodiments;

FIG. 2 depicts a graphical representation of a network of data-processing devices in which aspects of the present embodiments may be implemented;

FIG. 3 depicts a computer software system for directing the operation of the data-processing system depicted in FIG. 1, in accordance with an example embodiment;

FIG. 4 depicts a flow chart of steps associated with a method for selectively printing the documents resulting from a search in accordance with the disclosed embodiments;

FIG. 5 depicts flow chart of steps associated with method for selectively printing the documents resulting from a search in accordance with the disclosed embodiments;

FIG. 6A depicts an exemplary graphical user interface in accordance with disclosed embodiments;

FIG. 6B depicts an exemplary graphical user interface in accordance with disclosed embodiments;

FIG. 6C depicts an exemplary graphical user interface in accordance with disclosed embodiments;

FIG. 7 depicts an exemplary dialogue box associated with a graphical user interface in accordance with the disclosed embodiments;

FIG. 8 depicts a flow chart of steps associated with a method for returning search results and selectively printing data from the search results in accordance with the disclosed embodiments; and

FIG. 9 depicts a block diagram of a system for searching data locations and selectively printing results of such a search in accordance with the disclosed embodiments.

### DETAILED DESCRIPTION

The particular values and configurations discussed in the following non-limiting examples can be varied, and are cited merely to illustrate one or more embodiments and are not intended to limit the scope thereof.

Example embodiments will now be described more fully hereinafter with reference to the accompanying drawings, in which illustrative embodiments are shown. The embodiments disclosed herein can be embodied in many different forms and should not be construed as limited to the embodiments set forth herein; rather, these embodiments are provided so that this disclosure will be thorough and complete, and will fully convey the scope of the embodiments to those skilled in the art. Like numbers refer to like elements throughout.

The terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”), or “containing” (and any form of containing, such as “contains” and “contain”) are inclusive or open-ended and do not exclude additional, unrecited elements, or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AAB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those skilled in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

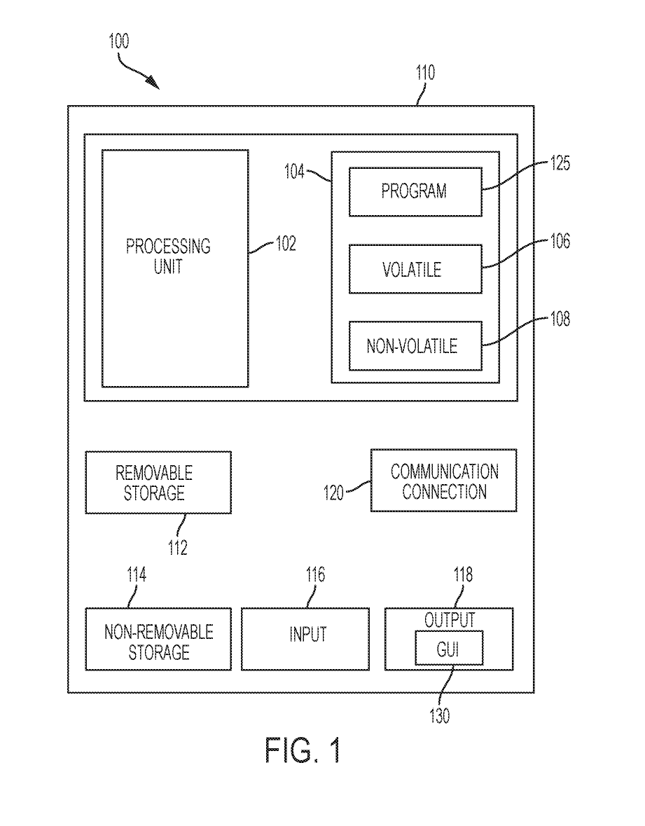

FIGS. 1-3 are provided as exemplary diagrams of data-processing environments in which embodiments of the present invention may be implemented. It should be appreciated that FIGS. 1-3 are only exemplary and are not intended to assert or imply any limitation with regard to the environments in which aspects or embodiments of the disclosed embodiments may be implemented. Many modifications to the depicted environments may be made without departing from the spirit and scope of the disclosed embodiments.

A block diagram of a computer system 100 that executes programming for implementing parts of the methods and systems disclosed herein is shown in FIG. 1. A computing device in the form of a computer 110 configured to interface with controllers, peripheral devices, and other elements disclosed herein may include one or more processing units 102, memory 104, removable storage 112, and non-removable storage 114. Memory 104 may include volatile memory 106 and non-volatile memory 108. Computer 110 may include or have access to a computing environment that includes a variety of transitory and non-transitory computer-readable media such as volatile memory 106 and non-volatile memory 108, removable storage 112 and non-removable storage 114. Computer storage includes, for example, random access memory (RAM), read only memory (ROM), erasable programmable read-only memory (EPROM) and electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage, or other magnetic storage devices, or any other medium capable of storing computer-readable instructions as well as data including image data.

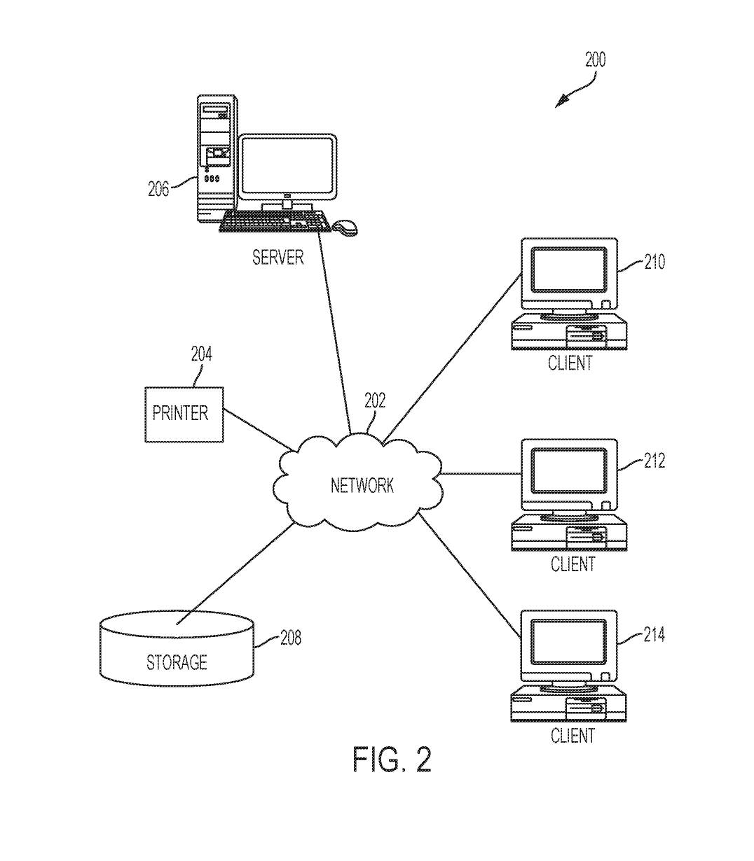

Computer 110 may include, or have access to, a computing environment that includes input 116, output 118, and a communication connection 120. The computer may operate in a networked environment using a communication connection 120 to connect to one or more remote computers, remote sensors and/or controllers, detection devices, hand-held devices, multi-function devices (MFDs), speakers, mobile devices, tablet devices, mobile phones, Smartphone, or other such devices. The remote computer may also include a personal computer (PC), server, router, network PC, RFID enabled device, a peer device or other common network node, or the like. The communication connection may include a Local Area Network (LAN), a Wide Area Network (WAN), Bluetooth connection, or other networks. This functionality is described more fully in the description associated with FIG. 2 below.

Output 118 is most commonly provided as a computer monitor, but may include any output device. Output 118 and/or input 116 may include a data collection apparatus associated with computer system 100. In addition, input 116, which commonly includes a computer keyboard and/or pointing device such as a computer mouse, computer track pad, or the like, allows a user to select and instruct computer system 100. A user interface can be provided using output 118 and input 116. Output 118 may function as a display for displaying data and information for a user, and for interactively displaying a graphical user interface (GUI) 130.

Note that the term “GUI” generally refers to a type of environment that represents programs, files, options, and so forth by means of graphically displayed icons, menus, and dialog boxes on a computer monitor screen. A user can interact with the GUI to select and activate such options by directly touching the screen and/or pointing and clicking with a user input device 116 such as, for example, a pointing device such as a mouse, and/or with a keyboard. A particular item can function in the same manner to the user in all applications because the GUI provides standard software routines (e.g., module 125) to handle these elements and report the user's actions. The GUI can further be used to display the electronic service image frames as discussed below.

Computer-readable instructions, for example, program module or node 125, which can be representative of other modules or nodes described herein, are stored on a computer-readable medium and are executable by the processing unit 102 of computer 110. Program module or node 125 may include a computer application. A hard drive, CD-ROM, RAM, Flash Memory, and a USB drive are just some examples of articles including a computer-readable medium.

FIG. 2 depicts a graphical representation of a network of data-processing systems 200 in which aspects of the present invention may be implemented. Network data-processing system 200 can be a network of computers or other such devices, such as mobile phones, smartphones, sensors, controllers, speakers, tactile devices, and the like, in which embodiments of the present invention may be implemented. Note that the system 200 can be implemented in the context of a software module such as program module 125. The system 200 includes a network 202 in communication with one or more clients 210, 212, and 214. Network 202 may also be in communication with one or more printing devices 204, servers 206, and storage 208. Network 202 is a medium that can be used to provide communications links between various devices and computers connected together within a networked data processing system such as computer system 100. Network 202 may include connections such as wired communication links, wireless communication links of various types, and fiber optic cables. Network 202 can communicate with one or more servers 206, one or more external devices such as multifunction device or printer 204, and a memory storage unit such as, for example, memory or database 208. It should be understood that printing device 204 may be embodied as a printer, copier, fax machine, scanner, multifunction device, rendering machine, photo-copying machine, or other such rendering device.

In the depicted example, printer 204, server 206, and clients 210, 212, and 214 connect to network 202 along with storage unit 208. Clients 210, 212, and 214 may be, for example, personal computers or network computers, handheld devices, mobile devices, tablet devices, smartphones, personal digital assistants, printing devices, recording devices, speakers, MFDs, etc. Computer system 100 depicted in FIG. 1 can be, for example, a client such as client 210 and/or 212 and/or 214.

Computer system 100 can also be implemented as a server such as server 206, depending upon design considerations. In the depicted example, server 206 provides data such as boot files, operating system images, applications, and application updates to clients 210, 212, and/or 214. Clients 210, 212, and 214 and printing device 204 are clients to server 206 in this example. Network data-processing system 200 may include additional servers, clients, and other devices not shown. Specifically, clients may connect to any member of a network of servers, which provide equivalent content.

In the depicted example, network data-processing system 200 is the Internet, with network 202 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, government, educational, and other computer systems that route data and messages. Of course, network data-processing system 200 may also be implemented as a number of different types of networks such as, for example, an intranet, a local area network (LAN), or a wide area network (WAN). FIGS. 1 and 2 are intended as examples and not as architectural limitations for different embodiments of the present invention.

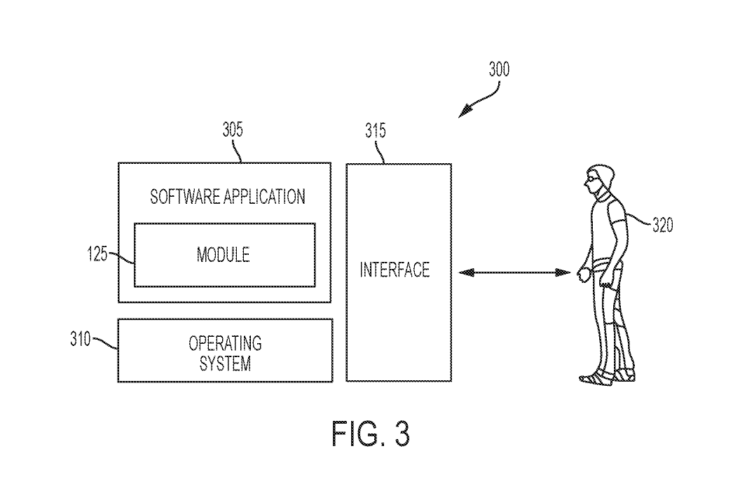

FIG. 3 illustrates a software system 300, which may be employed for directing the operation of the data-processing systems such as computer system 100 depicted in FIG. 1. Software application 305, may be stored in memory 104, on removable storage 112, or on non-removable storage 114 shown in FIG. 1, and generally includes and/or is associated with a kernel or operating system 310 and a shell or interface 315. One or more application programs, such as module(s) or node(s) 125, may be “loaded” (i.e., transferred from removable storage 112 into the memory 104) for execution by the data-processing system 100. The data-processing system 100 can receive user commands and data through user interface 315, which can include input 116 and output 118, accessible by a user 320. These inputs may then be acted upon by the computer system 100 in accordance with instructions from operating system 310 and/or software application 305 and any software module(s) 125 thereof.

Generally, program modules (e.g., module 125) can include, but are not limited to, routines, subroutines, software applications, programs, objects, components, data structures, etc., that perform particular tasks or implement particular abstract data types and instructions. Moreover, those skilled in the art will appreciate that elements of the disclosed methods and systems may be practiced with other computer system configurations such as, for example, hand-held devices, mobile phones, smartphones, tablet devices, multi-processor systems, microcontrollers, printers, copiers, fax machines, multi-function devices, data networks, microprocessor-based or programmable consumer electronics, networked personal computers, minicomputers, mainframe computers, servers, medical equipment, medical devices, and the like.

Note that the term “module” or “node” as utilized herein may refer to a collection of routines and data structures that perform a particular task or implements a particular abstract data type. Modules may be composed of two parts: an interface, which lists the constants, data types, variables, and routines that can be accessed by other modules or routines; and an implementation, which is typically private (accessible only to that module) and which includes source code that actually implements the routines in the module. The term module may also simply refer to an application such as a computer program designed to assist in the performance of a specific task such as word processing, accounting, inventory management, etc., or a hardware component designed to equivalently assist in the performance of a task.

The interface 315 (e.g., a graphical user interface 130) can serve to display results, whereupon a user 320 may supply additional inputs or terminate a particular session. In some embodiments, operating system 310 and GUI 130 can be implemented in the context of a “windows” system. It can be appreciated, of course, that other types of systems are possible. For example, rather than a traditional “windows” system, other operation systems such as, for example, a real-time operating system (RTOS) more commonly employed in wireless systems may also be employed with respect to operating system 310 and interface 315. The software application 305 can include, for example, module(s) 125, which can include instructions for carrying out steps or logical operations such as those shown and described herein.

The following description is presented with respect to embodiments of the present invention, which can be embodied in the context of, or require the use of, a data-processing system such as computer system 100, in conjunction with program module 125, and data-processing system 200 and network 202 depicted in FIGS. 1-3. The present invention, however, is not limited to any particular application or any particular environment. Instead, those skilled in the art will find that the system and method of the present invention may be advantageously applied to a variety of system and application software including database management systems, word processors, and the like. Moreover, the present invention may be embodied on a variety of different platforms including Windows, Macintosh, UNIX, LINUX, Android, Arduino, and the like. Therefore, the descriptions of the exemplary embodiments, which follow, are for purposes of illustration and not considered a limitation.

The embodiments disclosed herein are drawn to methods and systems for printing one or more pages from a single document, or multiple documents, within a folder and/or sub-folder listed as a result of filtering for specific keyword/s, headings, or sections in the documents or folders. The filter can be applied within a single document or multiple documents from different sources. A list of pages in the document can be identified by searching for a specific keyword, or keywords, and a GUI can be provided to facilitate selection of documents to be printed all at once or as needed.

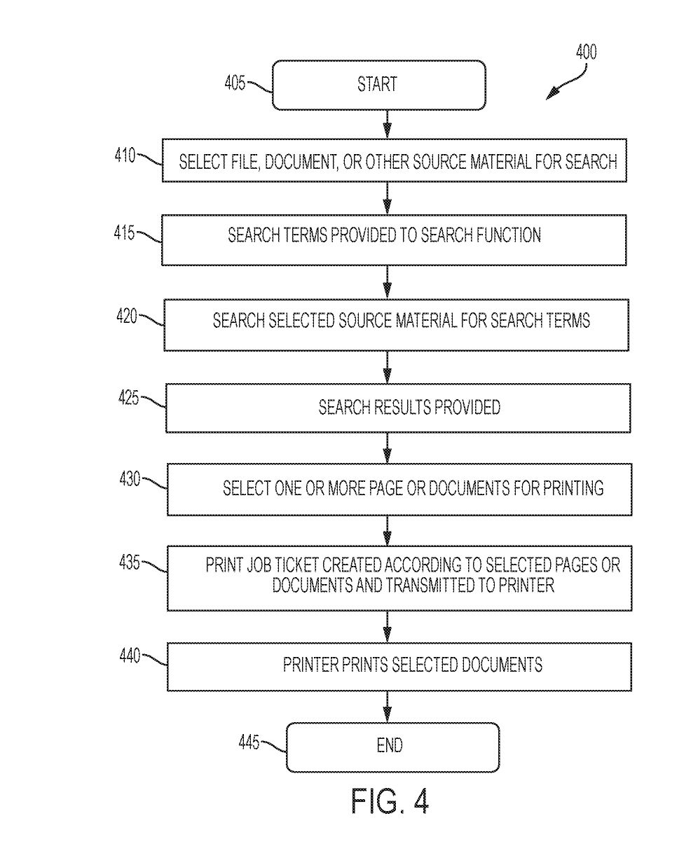

FIG. 4 illustrates a method 400 associated with the embodiments disclosed herein. The method begins at step 405. At step 410, a file of any source format can be selected by a user. Once the file has been selected, at step 415, a user can input a specific keyword or keywords, header or headers, section, sub-section, or other such identifying feature.

At step 420, a search of the selected data, document, or documents according to the selected search parameters can be performed. This search can be made irrespective of the search parameter properties or position in the documents. The search can be based on criteria defined by specific keywords, headers, footers, sentences, paragraphs, sections, sub-sections, tables, etc., and can be made of a single or multiple documents of different source types. The algorithm can accept a specific keyword to be searched for a single or multiple hit within a file or group of files in a folder, based on the search criteria defined in a fact file which can be pre-configured or dynamically configurable. The fact file defines the rule to identify the content without any limitations. In other embodiments, other searching algorithms can be used. In certain embodiments, the search criteria can be applied to documents of folders and sub-folders stored in a physical storage media. Additionally, the search criteria can be applied to documents of folders stored in the cloud with a utility like google drive, dropbox, etc. In certain embodiments, the search criteria can be further expanded to web crawling or other electronic data storage applications.

The search results in a list of pages in the document or documents as shown at step 425. The list can be provided to the user in a GUI or other such display. The user is thus able to view the list of pages in the document or folder automatically as a result of the input search criteria.

At this point, at step 430, one or more pages from the list view of pages or documents that meet the search criteria can be selected for printing. When the desired pages are selected, a new print job ticket can be prepared and transmitted to a printer, multifunction device, or other such rendering device, as shown at step 435. The print job includes only those jobs selected for printing. The job is then printed at step 440 and the method ends at step 445.

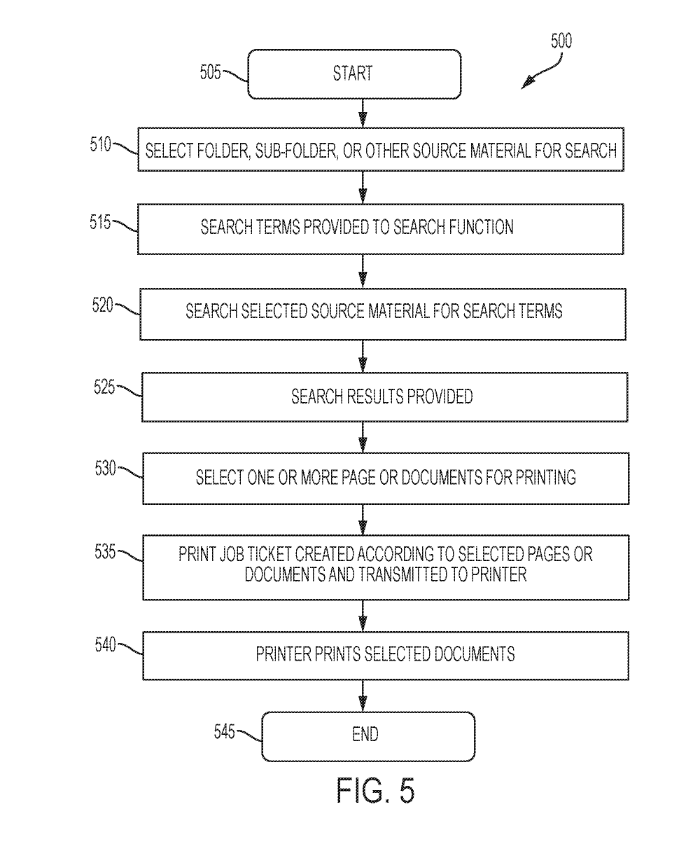

In a similar embodiment, illustrated in FIG. 5, a method 500 can begin at step 505. Selection of a folder or sub-folder where there are one or more documents stored can be made at step 510. Next, at step 515, a user can input a specific keyword or keywords, header or headers, section, sub-section, or other such identifying feature.

Next at step 520, a search of the selected document or documents according to the selected search parameters can be performed irrespective of their properties or position in the documents. The search can be based on criteria defined by specific keywords, headers, footers, sentences, paragraphs, sections, sub-sections, tables, etc., and can be made of a single or multiple documents of different source types. The searching algorithm can accept a specific keyword to be searched for a single or multiple hit within a file, or group of files, in a folder, based on the search criteria defined in a fact file which is pre-configured or dynamically configurable. The fact file can define the rule to identify the content without any limitation. In other embodiments, other known searching algorithms can be used. In certain embodiments, the search criteria can be applied to documents of folders and sub-folders stored in a physical storage media. Additionally, the search criteria can be applied to documents or folders stored in the cloud with a utility like Google drive, Dropbox, etc. In certain embodiments, the search criteria can further be expanded to web crawling or other electronic data storage applications.

The search results in a list of pages and/or document, as shown at step 525. The user gets to view the list of pages (i.e., a single document or multiple documents) automatically from multiple documents with different sources. At step 530, the one or more pages from the list view, which met the search criteria, can be selected to print. When the desired page is selected, a new print job ticket can be prepared and transmitted to a printer, as shown at step 535. The print job includes only those jobs selected for printing. The job is then printed at step 540 and the method ends at step 545.

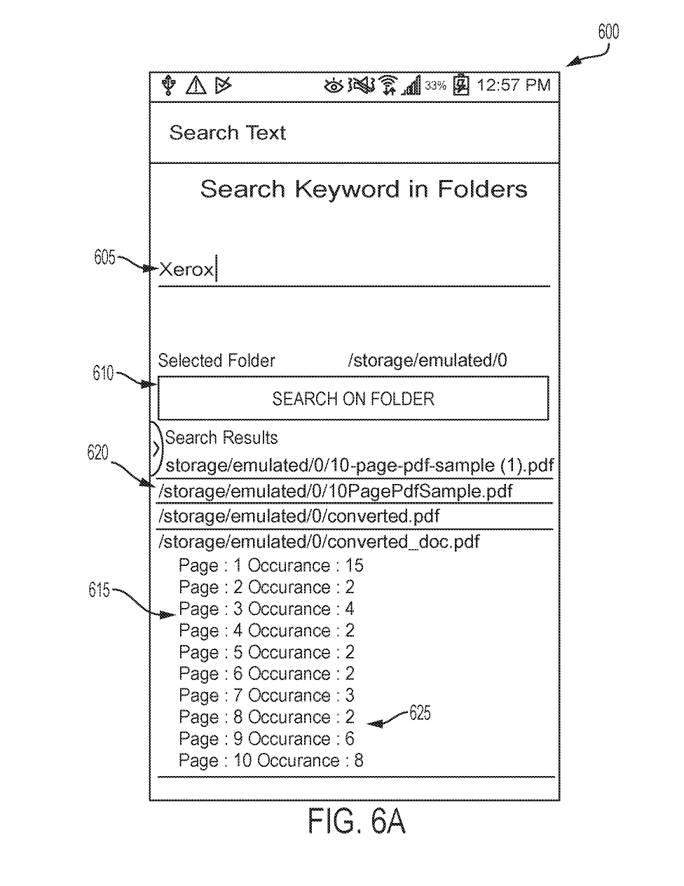

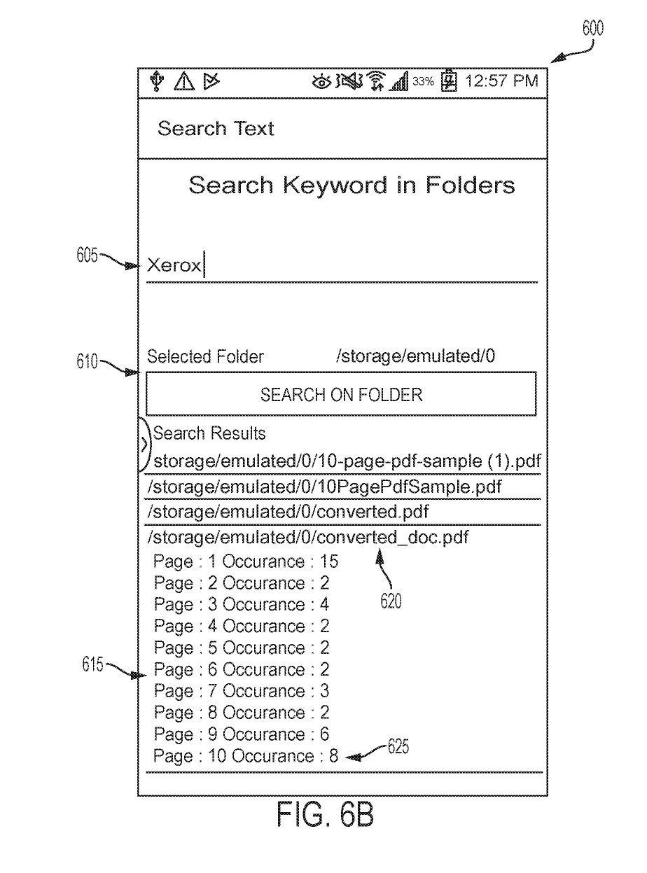

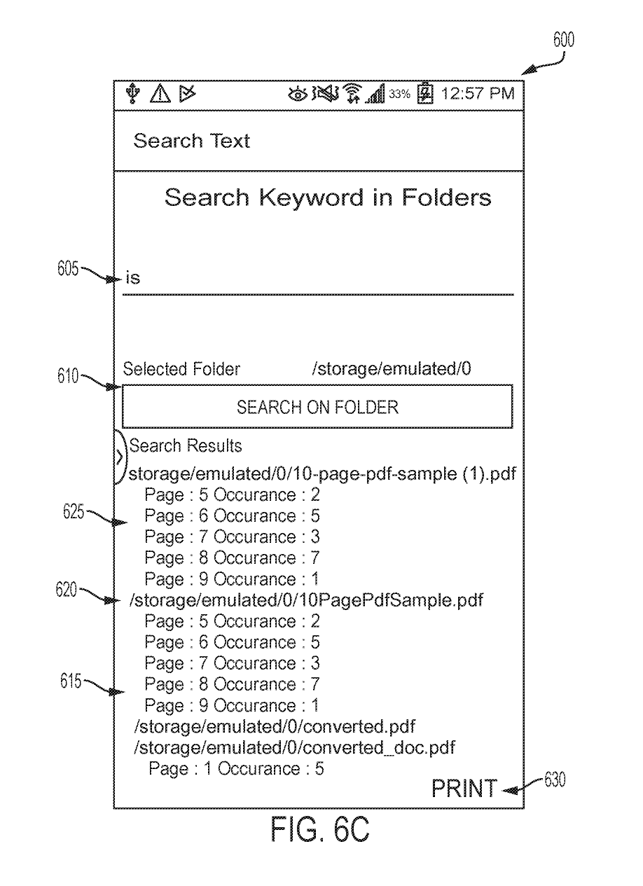

FIGS. 6A, 6B, and 6C illustrate an exemplary graphical user interface 600 for providing a user the ability to print one or more documents identified as containing a desired search term. As illustrated, the user interface 600 can include a search field 605. One or more search terms or phrases can be entered in the search field 605. In addition, a field for selecting the documents, folder, or other data sources 610 can be provided in the GUI 600. The field 610 allows the user to select one or more sources for the desired keywords.

Upon entering a search word or phrase in search field 605, a list 615 of pages or documents where the selected search word appears can be presented. The list can include a callout 620 to the source document, folder, and/or storage location, a page on which the keyword appears, and a number field 625 that indicates the number of times the search phrase appears on the associated page. It should be understood that the GUI can be customized to allow the user to view documents according to the user's preferences.

The GUI 600 can be configured to include a selection utility associated with an input device, that allows the user to select one or more documents, or pages in the list 615, that the user desires to print. The user can select each of the desired pages on the list or can choose a “select all” option to choose every page or document that includes the search word or phrase. The desired pages for printing can be selected. A print button 630 can be provided, as shown in FIG. 6C. By choosing the “print” option, the system can generate a print job ticket that includes only those pages selected by the user using the GUI. The print ticket is transmitted to a printer so that the selected pages or documents are printed.

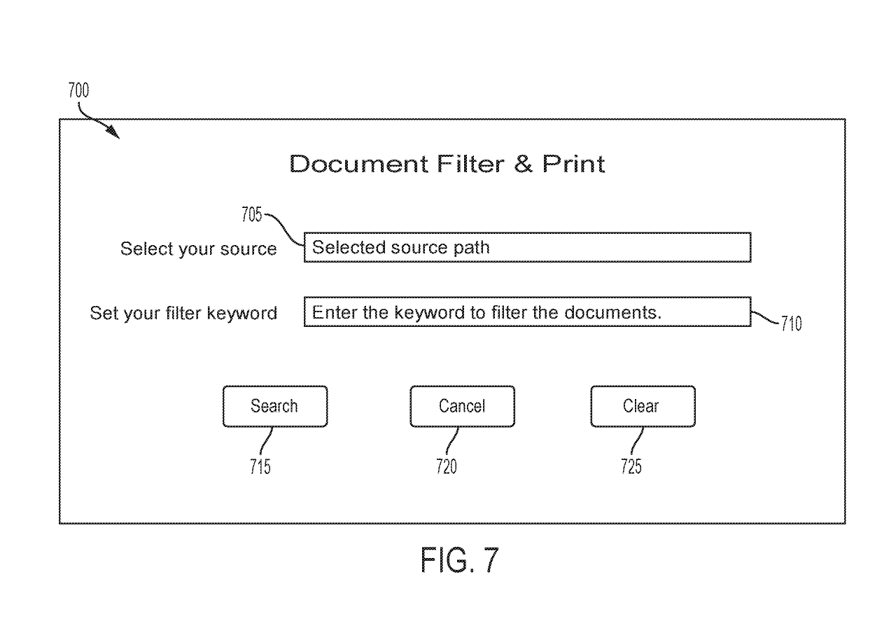

FIG. 7 illustrates an exemplary dialogue box 700 associated with a GUI, such as GUI 600 for searching one or more documents, pages of a document, one or more folders, and/or sub-folders. The dialogue box 700 can be provided when a user navigates the GUI 600 and selects a “filter and print” option to print one or more documents, pages of a document, folder, sub-folder, etc.

The dialogue box 700 includes a field 705 to select a source for searching. When the user selects this field, the user can enter a destination, or file path, of a specific file, folder, sub-folder, document, etc. In other embodiments, the user can navigate a set of cascading or nested file locations provided in the GUI 600, according to the memory architecture of the local device or cloud storage. For example, the initial search location could be the hard drive of a device such as computer 110. The user can then select a subfolder on the hard drive, such as a folder dedicated to the user. From there the user can continue to navigate through various nested sub-locations until the desired file, folder, sub-folder, document, etc., is identified. Multiple desired files, folders, sub-folders, documents, etc., can be selected if desired. The GUI 600 can provide a user control to finally select the desired data location(s). The file path of the desire location(s) can then appear in the field 705.

The dialogue box 700 includes a second field 710 that allows input of a keyword, string, phrase, or the like, for filtering. The user can key in or otherwise provide the desired search terms. If the “Search” button 715 is selected, the selected location can be searched for the keyword(s), string, phrase, or the like, resulting in a display of results as illustrated in FIG. 6. Alternatively, the request can be cancelled by selecting the “cancel” button 720, or the data entered in field 705 and field 710 can be cleared by selecting the “clear” button 725.

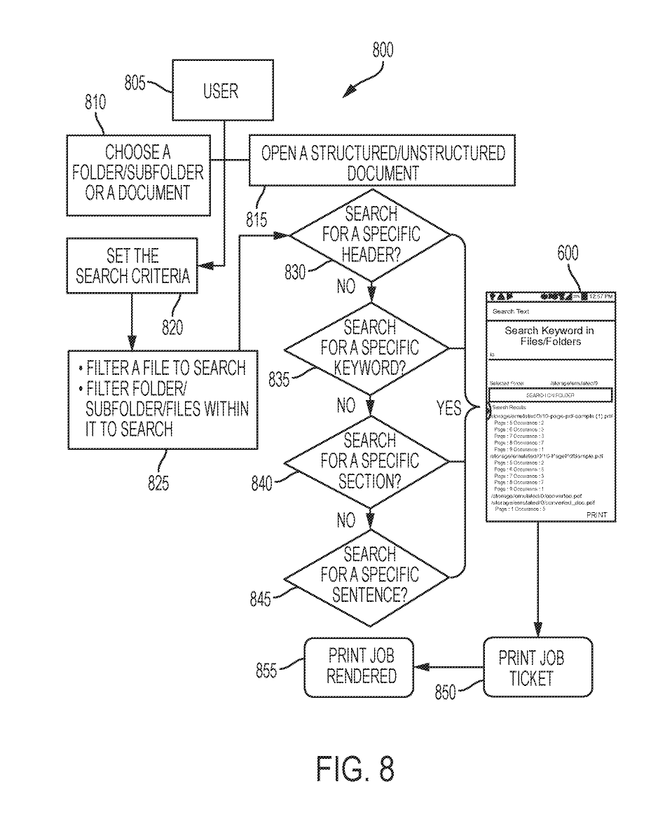

FIG. 8 illustrates a process flow 800 associated with the methods and systems disclosed herein. As process flow 800 illustrates, a user 805 can choose a folder or subfolder of a document as shown at block 810. The system can open the structured or unstructured document as shown at block 815.

The user 805 can then set the search criteria at block 820. The search criteria can include, but is not limited to, a keyword search, a search of a document header or title, a search for a document section, a search for a string, a search of a sentence, or other such characteristic of a document. After the search criteria is set, the system can filter the files to search and/or filter folders, subfolders, or files within the folder, as illustrated at block 825.

The search itself includes a review of the selected folders, subfolders, files, documents, etc., for the search criteria. In FIG. 8, exemplary search criteria include a search for a specific header at block 830, a search for a specific keyword at block 835, a search for a specific section at block 840, and a search for a specific sentence at block 845. It should be appreciated that, in certain embodiments, the user can choose any one of the exemplary search criteria shown, a combination of the search criteria shown, and/or can select other such search criteria.

The results of the search are provided to the user in a GUI, such a GUI 600, as illustrated in FIGS. 6A-6C. The search results can list the files, folders, subfolders, documents, document sections, etc., that meet the selected search criteria, along with a list of the number of times the search criteria were met for each of the listed files, folders, subfolders, documents, document sections. The GUI can further provide the user the ability to select one or more of the files, folders, subfolders, documents, and/or document sections that meet the search criteria. With the desired files, folders, subfolders, documents, document sections selected, a “print” button can be used to create a print job ticket at block 850. The print job ticket is sent to a rendering device such as a printer, multi-function device, or other such device for rendering at block 855.

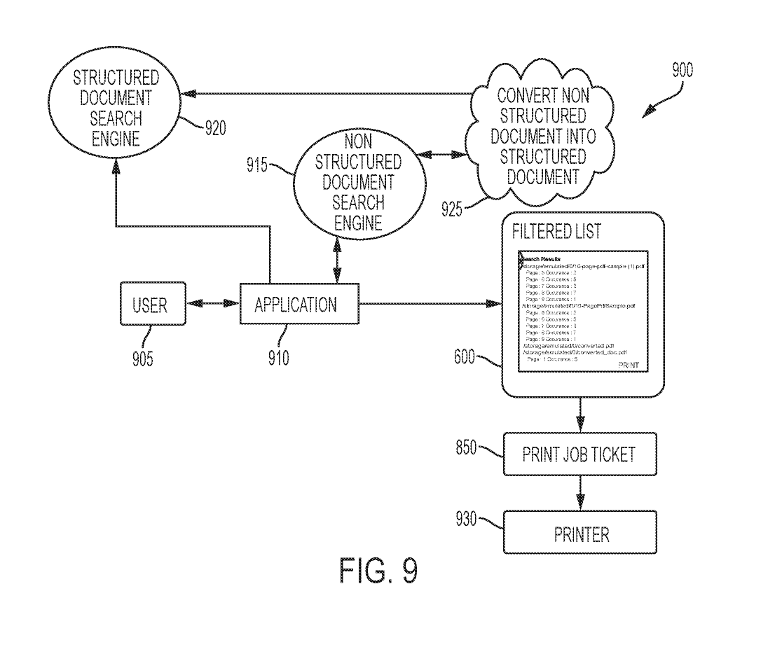

FIG. 9 illustrates a system diagram of a system 900 for printing select results from a search of multiple files, documents, folder, sub-folders, or the like. The system illustrates a user 905 that is in control of an application 910. The application 910 generally comprises a specially designed, and uniquely ordered combination of steps, implemented as software. The application includes a GUI, such as GUI 600, that allows the user 905 to interact with the application 910. The application 910 can be provided on a computer system, mobile device, tablet device, multifunction device, or other such device.

The application 910 operates as disclosed herein and as illustrated in FIGS. 4, 5, 6A, 68, 6C, and 8. The application 910 allows the user 905 to enter search parameters that define the data locations to be searched. These can include data locations local to the system running the application, or remote data locations such as a networked storage device, the cloud, or other remote data locations. The application also allows the user 905 to enter search criteria including, but not limited to, specific keyword or keywords, header or headers, section, sub-section, or other such identifying feature.

In an embodiment, the application 910 can determine if the data structure to be searched is structured or non-structured. If the data location is a structured document (or other such data location), the application 910 sends the document to be searched by search engine 920, and the results of the search are returned, and presented in GUI 600 of the application 910, as disclosed herein. If the data location is non-structured 915, the application can convert the non-structured document (or other selected data location) into a structured document (or other such data location) 925. The structured data location can then be searched with search engine 920 and the results of the search are returned, and presented in GUI 600 of the application 910, as disclosed herein. Upon the user 905 selecting “print,” a print job ticket 850 can be created and the job can be rendered by rendering device 930.

Based on the foregoing, it can be appreciated that a number of embodiments, preferred and alternative, are disclosed herein. For example, in one embodiment, a system comprises a rendering device, at least one processor, and a storage device communicatively coupled to the at least one processor, the storage device storing instructions which, when executed by the at least one processor, cause the at least one processor to perform operations comprising: searching at least one data location, returning results of the search, selecting discrete members of the search results, and printing the selected discrete members.

In an embodiment, the at least one processor can cause the at least one processor to perform operations further comprising selecting parameters for the search. The parameters can comprise at least one of a keyword, a header, a header section, a section, a sub-section, and a table.

In an embodiment, the at least one processor can cause the at least one processor to perform operations further comprising selecting at least one data location for searching. The data location can comprise at least one of: a document, multiple documents, a folder, and a sub-folder. In an embodiment, the data location comprises at least one of the storage device, a local storage device, and a cloud storage location.

In an embodiment, the system further comprises a graphical user interface the graphical user interface comprising: at least one field for entering data, a field for displaying results of the search, an input for selecting discrete members of the search results, and a button for printing the selected discrete members of the search results.

In another embodiment, a method comprises searching at least one data location according to instructions executed by at least one processor, returning results of the search, selecting discrete members of the search results, and printing the selected discrete members with a rendering device. In an embodiment, the method further comprises selecting parameters for the search according to instructions executed by at least one processor. The parameters can comprise at least one of a keyword, a header, a header section, a section, a sub-section, and a table.

In an embodiment, the method further comprises selecting at least one data location for searching. The data location can comprise at least one of: a document, multiple documents, a folder, and a sub-folder. The data location can comprise at least one of the storage device, a local storage device, and a cloud storage location.

In an embodiment, the method further comprises providing a graphical user interface, entering data in at least one field associated with the graphical user interface, displaying results of the search in the graphical user interface, selecting discrete members of the search results with an input associated with the graphical user interface, and printing the selected discrete members of the search results with a button associated with the graphical user interface.

In yet another embodiment, an apparatus comprises a rendering device, at least one processor, and a storage device communicatively coupled to the at least one processor, the storage device storing instructions which, when executed by the at least one processor, cause the at least one processor to perform operations comprising: selecting parameters for a search, selecting at least one data location for searching, searching the at least one data location, returning results of the search, selecting discrete members of the search results, and printing the selected discrete members. In an embodiment, the parameters comprise at least one of a keyword, a header, a header section, a table, a section, and a sub-section.

In an embodiment of the apparatus, the data location comprises at least one of the storage device, a local storage device, and a cloud storage location. In an embodiment, the data location can further comprises at least one of a document, multiple documents, a folder, and a sub-folder.

In an embodiment, the apparatus further comprises a graphical user interface, the graphical user interface comprising: at least one field for entering data, a field for displaying results of the search, an input for selecting discrete members of the search results, and a button for printing the selected discrete members of the search results.

In an embodiment, the rendering device comprises one of a printer, a copy machine, a fax machine, and a multifunction device.

It will be appreciated that variations of the above-disclosed and other features and functions, or alternatives thereof, may be desirably combined into many other different systems or applications. Also, it should be understood that various presently unforeseen or unanticipated alternatives, modifications, variations or improvements therein may be subsequently made by those skilled in the art which are also intended to be encompassed by the following claims.

1. A system comprising:
a rendering device;
a computer system communicatively coupled to said rendering device, said computer system comprising:
at least one processor; and
a storage device communicatively coupled to said at least one processor, said storage device storing instructions which, when executed by said at least one processor, cause said at least one processor to perform operations comprising:
selecting parameters for a search wherein one of said parameters comprises a keyword and additional search parameters comprise: a header, a section, a sub-section, and a table;
searching at least one data location;
returning results of said search wherein said search result comprises a list of discrete members of said search;
selecting some of said discrete members of said search results; and
printing said selected discrete members.

2. (canceled)

3. (canceled)

4. The system of claim 1 wherein said instructions, when executed by said at least one processor, cause said at least one processor to perform operations further comprising:
selecting at least one data location remote from said rendering device for searching.

5. The system of claim 4 wherein said data location comprises at least one of:
a document;
multiple documents;
a folder; and
a sub-folder.

6. The system of claim 1 wherein said data location comprises at least one of:
said storage device;
a local storage device; and
a cloud storage location.

7. The system of claim 1 further comprising:
a graphical user interface said graphical user interface comprising:
a field for entering data;
a field for displaying results of said search;
an input for selecting discrete members of said search results; and
a button for printing said selected discrete members of said search results.

8. A method comprising:
selecting parameters for a search by providing instructions executed by a computer system comprising at least one processor, said parameters comprising: a header, a section, a sub-section, and a table;
searching at least one data location according to instructions executed by a computer system further comprising at least one processor;
returning results of said search wherein said results of said search further comprises a list of discrete members of said search;
selecting some discrete members of said search results from said list of discrete members of said search; and
printing said selected discrete members with a rendering device.

9. (canceled)

10. (canceled)

11. The method of claim 8 further comprising:
selecting at least one data location remote from said rendering device for searching.

12. The method of claim 11 wherein said data location comprises at least one of:
a document;
multiple documents;
a folder; and
a sub-folder.

13. The method of claim 8 wherein said data location comprises at least one of:
said storage device;
a local storage device; and
a cloud storage location.

14. The method of claim 8 further comprising:
providing a graphical user interface;
entering data in a field associated with said graphical user interface;
displaying results of said search in said graphical user interface
selecting discrete members of said search results with an input associated with said graphical user interface; and
printing said selected discrete members of said search results with a button associated with said graphical user interface.

15. An apparatus comprising:
a rendering device;
a computer system communicatively coupled to said rendering device, said computer system comprising:
at least one processor; and
a storage device communicatively coupled to said at least one processor, said storage device storing instructions which, when executed by said at least one processor, cause said at least one processor to perform operations comprising:
selecting parameters for a search said parameters comprising a keyword, a header, a table, a section, and a sub-section,
selecting at least one data location remote from said rendering device for searching;
searching said at least one data location;
returning results of said search wherein said results of said search comprises a list of discrete members of said search;
selecting some of said discrete members of said search results; and
printing said selected discrete members.

16. (canceled)

17. The apparatus of claim 15 wherein said data location remote from said rendering device comprises at least one of:
said storage device;
a local storage device; and
a cloud storage location.

18. The apparatus of claim 17 wherein said data location remote from said rendering device comprises at least one of:
a document;
multiple documents;
a folder; and
a sub-folder.

19. The apparatus of claim 15 further comprising:
a graphical user interface said graphical user interface comprising:
a field for entering data;
a field for displaying results of said search;
an input for selecting discrete members of said search results; and
a button for printing said selected discrete members of said search results.

20. The apparatus of claim 15 wherein said rendering device comprises one of:
a printer;
a copy machine;
a fax machine; and
a multifunction device.
